(19) United States
(12) Patent Application Publication
(10) Pub. No.: US 2008/0016740 A1
(43) Pub. Date: Jan. 24, 2008

(54) Integrally Extruded Price Tag Molding and Front-End Stop Plate for Gravity-Feed Shelving

(76) Inventors: J. Patrick Mitten, Barrington, IL (US); Henry J. Massett, Evergreen Park, IL (US); Joseph Coretti, Wheaton, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/556,994

(22) Filed: Nov. 6, 2006

Related U.S. Application Data
(60) Provisional application No. 60/806,418, filed on Jun. 30, 2006.

(51) Int. Cl. G09F 3/18

(52) U.S. Cl. 40/649

(57) ABSTRACT

An integrally extruded price tag molding and front-end stop plate for use on a flat shelf or inclined gravity-feed shelf, wherein the height of the stop plate may be designed to safely keep contents of each dispensing track from falling onto the floor. The angle of the price tag molding may be designed to facilitate its viewing by the consumer. The mounting rail clamp portion of the unit may be designed to facilitate the installation of the unit onto the front rail of any shelf in the display. The upper and lower price tag channels may be designed in order to accept a variety of labelling media or advertising indicia.

### REFERENCE TO RELATED APPLICATIONS

This application claims priority to U.S. Provisional Application No. 60/806,418, filed Jun. 30, 2006, and is entitled to the benefit of the filing date of that provisional application for all subject matter commonly disclosed therein.

### FIELD OF THE DISCLOSURE

This disclosure relates to controlled display of retail merchandise, such as gravity-feed shelving, and more specifically, to an integrally extruded price tag molding and front-end stop plate for use along a front edge of a shelf of a retail display shelving unit.

### BACKGROUND OF THE DISCLOSURE

In order to increase inventory turnover and maximize efficient use of shelf space, retailers frequently utilize gravity-feed shelving systems, wherein inclined shelves are used to stock merchandise. In such shelf systems, consumers are presented with an array of merchandise (food, drinks, sundries, etc.) arranged in one or more parallel tracks on each shelf, generally with only the front-most (“first-in” or “first-up”) unit of merchandise in each individual track being easily accessible, i.e. so-called “first-in-first-out” (or “FIFO”) product merchandising. Upon removing this front-most unit of merchandise, the remaining units of like-merchandise in that given track advance, i.e. slide down, toward the front of the shelf, so that the next-successive unit in line becomes the new front-most unit in that track.

As each unit of merchandise slides forward to the front of its respective track, it must be stopped from spilling onto the floor of a retail establishment. In order to stop the merchandise, it is common to provide a physical barrier along a front edge of the shelf. One such physical barrier is known as a front-end stop plate. While it has been known to provide price tag moldings with slots to receive front-end stop plates, such constructions have several shortcomings. For instance, the slots in which the front-end stop plates are received can be difficult to clean. Once a stop plate has been removed from an associated slot along a price tag molding for cleaning of the slots, it can be difficult to reinstall the front-end stop plate. The manner in which these and other shortcomings are overcome will be explained in the following Summary and Detailed Description sections of the present disclosure.

### SUMMARY OF THE DISCLOSURE

The present disclosure includes a price tag molding and a front-end stop plate formed together into an integral, one-piece unit. This integral unit can be installed onto a rail that spans the front of a shelf in a typical merchandise display case. The unit can be used not only to stop merchandise from advancing further than the front of each track, but also to display price tag(s) or other printed information to be associated with the merchandise on the track.

Advantageously, a price tag receiving channel at the forward leading edge of the price tag molding can receive labelling indicia therein, such as product names, flavors, ingredients, can/bottle/jar sizes, product weight, bar codes, and prices, at positions associated with, i.e. immediately forward and below, each track member of the shelf for the visual benefit of consumers and stock keeping personnel. This price tag channel could also be used to secure various types of product advertising or suspended consumer inducements (e.g. shelf talkers, coupon dispensers, blinking red lights, or the like). Depending on the display need, the shape of this price tag channel can be designed for what it must secure, and the angle at which this channel is directed toward the consumer can be determined during the design and manufacturing of the device. For example, the angle of incline may vary, to facilitate consumer viewing of indicia on lower versus higher shelves.

Preferably, the front rail of each shelf on a display unit will accept a price tag molding having a first channel that is generally U-shaped in cross-section and also having a stop plate in a position generally perpendicular to the plane of the inclined shelf. The front-end stop plate and price tag molding may be integrally extruded, preferably out of ABS plastic, and may be substantially clear at close distances. Clearer material for the stop plate reduces the visual impediment to the consumer, although translucency of the stop plate should not reduce its functionality, as long as the item displayed is not obscured from view. Because of the raised height of the rear rail and the angle of incline of the shelf, a stop plate at the rear of the shelf is generally not necessary to prevent the rear-most item on the shelf from being pushed backwards off of the shelf, for example, if the shelves are front-loaded.

### BRIEF DESCRIPTION OF THE SEVERAL VIEWS OF THE DRAWING

FIG. 1 is a front perspective view of a combination price tag molding and front-end stop, partially cut away, of the present disclosure;

FIG. 2 is a rear perspective view of the combination price tag molding and front-end stop shown in FIG. 1;

FIG. 3 is a side view of the combination price tag molding and front-end stop shown in FIG. 1;

FIG. 4 is an environmental front perspective view of multiple combination price tag moldings and front-end stops installed onto rails of a typical multiple-shelf display unit;

FIG. 5 is a front perspective view of a second embodiment of the present disclosure;

FIG. 6 is a rear perspective view of the embodiment shown in FIG. 5;

FIG. 7 is a side view of the embodiment shown in FIG. 5;

FIG. 8 is a front perspective view of a third embodiment of the present disclosure;

FIG. 9 is a rear perspective view of the embodiment shown in FIG. 8;

FIG. 10 is a side view of the embodiment shown in FIG. 8;

FIG. 11 is a front perspective view of a fourth embodiment of the present disclosure;

FIG. 12 is a rear perspective view of the embodiment shown in FIG. 11; and

FIG. 13 is a side view of the embodiment shown in FIG. 13.

It will be understood that the drawings are not to scale and that, in some instances, details which are not necessary for an understanding of the disclosed embodiments or which render other details difficult to perceive, may have been omitted. It should also be understood that this disclosure is not limited to the embodiments specifically illustrated in the drawings.

### DETAILED DESCRIPTION OF THE PREFERRED EMBODIMENTS

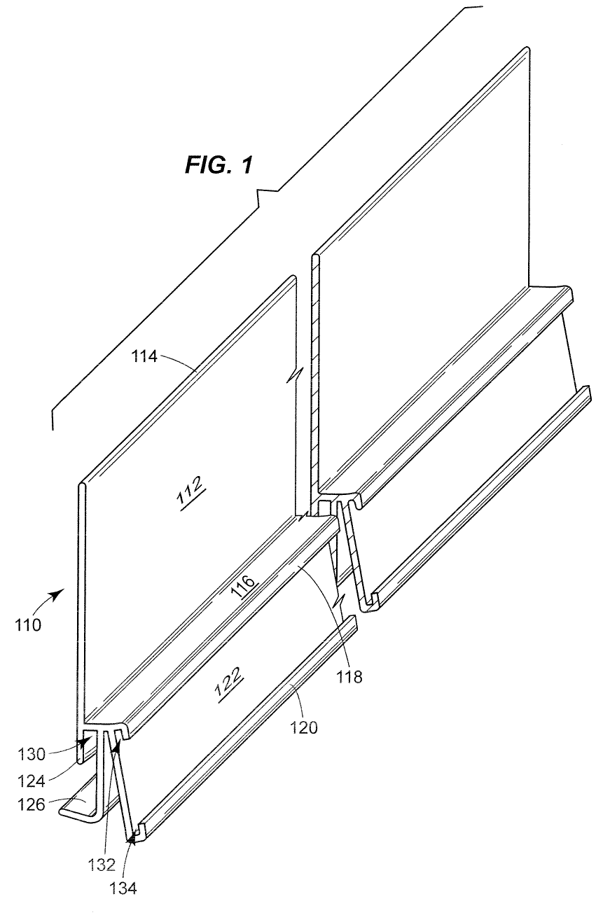

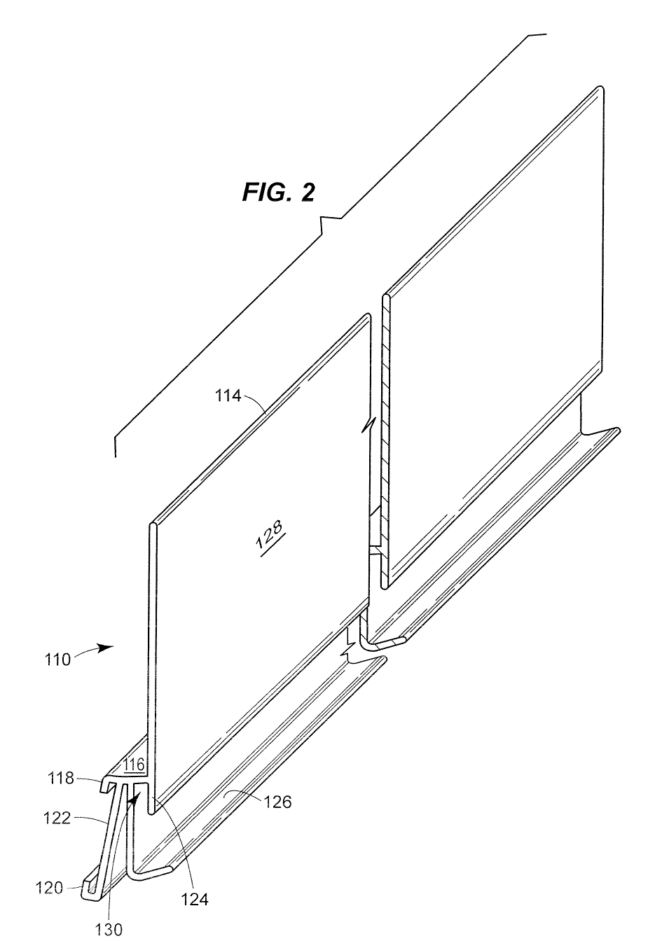

Having reference to the drawings, where like reference numbers comprise like elements, there is shown in FIG. 1 and FIG. 2 an integrally extruded price tag molding and front-end stop plate for gravity-feed shelving, generally denoted by reference numeral 110. The combination price tag molding-stop plate 110 includes a stop plate 112, which, in this embodiment, may include a top 114.

Each stop plate 112 is integrally connected to a price tag molding portion 122 just above an upper mounting rail clamp 124, which extends downwardly in a straight manner as a short extension of the stop plate 112. The manufactured height “h” of the stop plate 112 may be varied by the manufacturer in order to optimally stabilize any dispensed product. For example, gallon-sized glass milk bottles may need stop plates as high as about nine inches tall; whereas, relatively small containers, or containers having a lower center of gravity, may only need stop plates sized at about two inches tail.

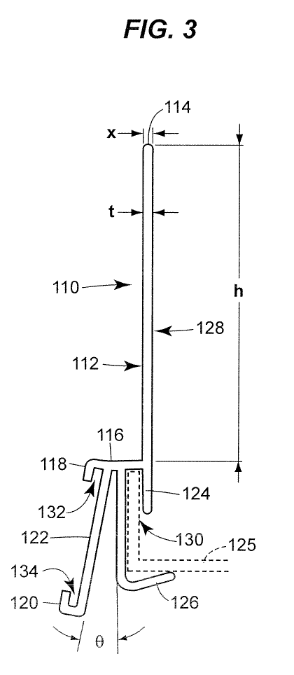

As shown in FIG. 3, the upper mounting rail clamp 124 cooperates with a lower mounting rail lower clip 126 to form a mounting rail channel 130. The upper mounting rail clamp 124 and the lower mounting rail clip 126 are in a plane that is generally parallel to, and offset from, a plane defined by the stop plate 112. The resiliency of the lower mounting rail clip 126 allows for the mounting rail channel 130 to be placed over a generally L-shaped (in cross-section) angle iron-type mounting rail 125 (shown in broken lines), thus surrounding it. The resiliency of the lower mounting rail clip 126 will also provide the clamping force necessary to secure the price tag molding-stop plate 110 to the mounting rail 125 upon installation.

As shown in FIGS. 1, 2, and 3, a connector ledge 116 is formed where the stop plate 112 joins the price tag molding portion 122. This connector ledge 116 has a manufactured bend to its bottom creating a trough-like indentation along the midsection its entire length. An upper overhang 118 is provided along the leading edge of the connector ledge 116. The upper overhang 118 defines an upper price tag receiving channel 132. Along the lower edge of the price tag molding 122, a lower overhang 120 is provided, which defines a lower price tag receiving channel 134. It is the combination of the upper price tag channel 132 and the lower price tag channel 134 which forms a price tag receiving channel or slot that may accept a price tag, or other labelling/advertising/identifying indicia, typically slid into place from a side.

It is the bend of the connector ledge 116 which determines the final angle Θ (see FIG. 3) at which the price tag molding 122 is disposed relative to the stop plate 112. The angle Θ can be designed and manufactured to maximize the visual effectiveness of the display for the consumer. Preferably, the angle Θ varies inversely with the height of an associated shelf to which the price tag molding—front end stop assembly is mounted. For example, price tag molding/stop plates used on the very bottom of display cases may need to have larger Θ angles in order for the average consumer to look downward and more easily see the label affixed thereon. Price tag molding-stop plates 110 installed at a height closer to consumer may need to have smaller Θ angles for easy viewing. Such Θ angles thus, can vary between approximately 0 and approximately 90 degrees. More preferably, the Θ angle will vary in the range between 30 and 60 degrees. Thus, the upper price tag channel 132 and lower price tag channel 134, together with the angle Θ, serve as a non-adhesive means for retaining indicia at an angle Θ relative to the stop plate 112.

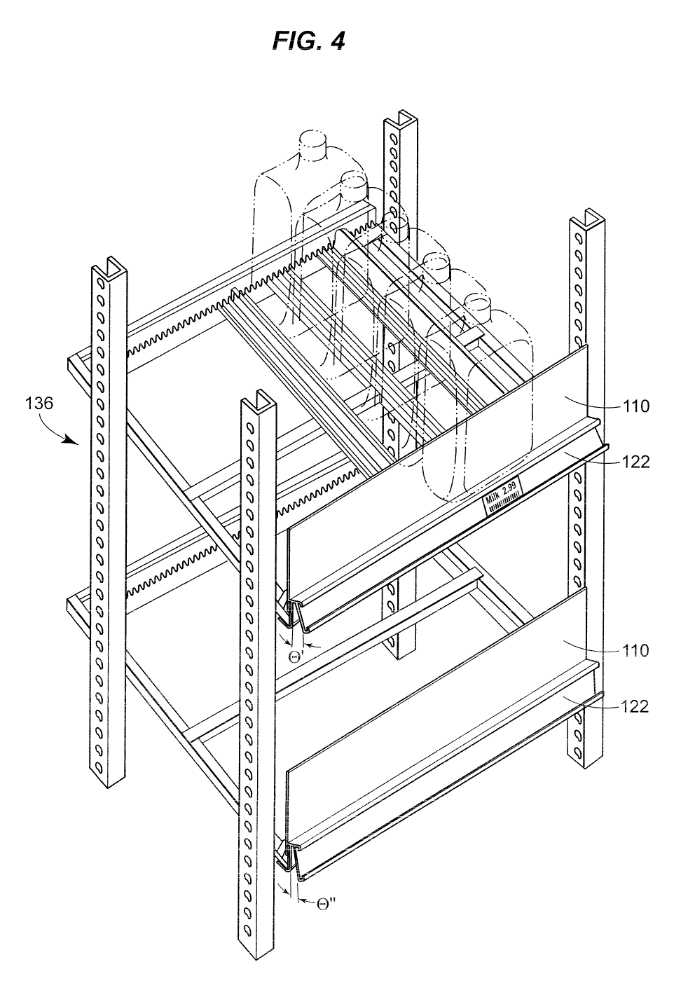

FIG. 4 shows how typical combination price tag moldings/stop plates 110 of the present disclosure may be installed on the front rail of each shelf of a multi-shelf gravity-feed display unit 136. More particularly, it can be noted that the front-end stop plate 110 portion of the disclosure is of a sufficient height as to prevent the gravity-fed glass milk bottles from falling forward onto the floor of the establishment. Also, it is noted that the top price tag molding 122 displayed has a small Θ angle (angle between the price tag molding face and the front-end stop plate) designated here by Θ′; whereas, the bottom price tag molding 122 displayed has a much larger Θ angle, designated here by Θ″, approaching 45 degrees, for example. In this bottom-shelf application, a larger Θ angle may better serve the viewing needs of the retail customer.

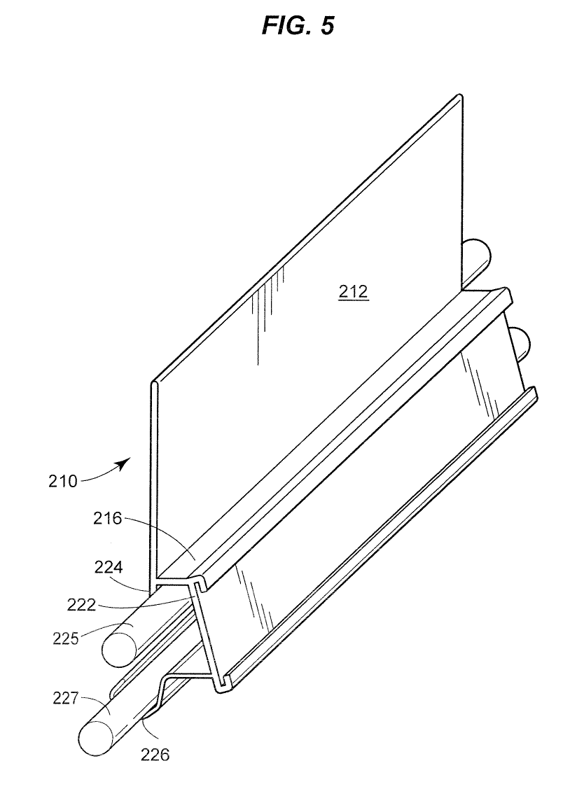

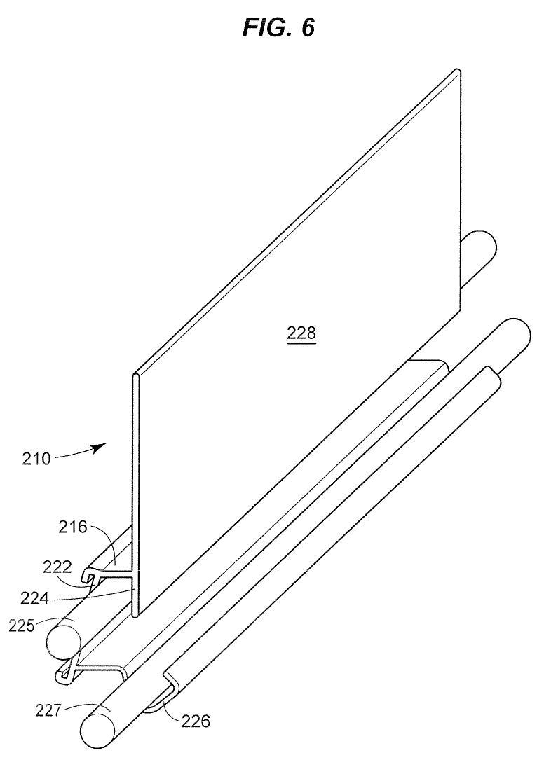

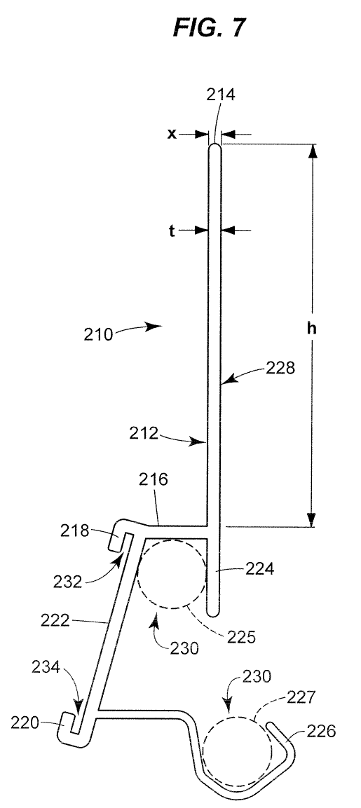

FIGS. 5, 6 and 7 show another embodiment of a price tag molding-stop plate 210 of the present disclosure, which may be used to attach to a pair of wire rod-type mounting rails 225, 227 of circular cross-section (as distinct from attaching to the generally L-shaped, angle iron-type mounting rail 125 of the previous embodiment of FIGS. 1, 2 and 3). A mounting rail channel 230 (see FIG. 7), created where an upper mounting rail clamp 224 joins a ledge 216 and an upper portion of a price tag molding 222 tightly surrounds and secures to an upper mounting rail 225. Similarly, a lower mounting rail clip 226 is provided to surround and be secured to a lower parallel, but offset, mounting rail 227. The curvature of the lower mounting rail clip 226 contributes to the necessary resiliency to facilitate surrounding the lower mounting rail 227 and securing the price tag molding-stop plate 210 to the pair of mounting rails 225, 227

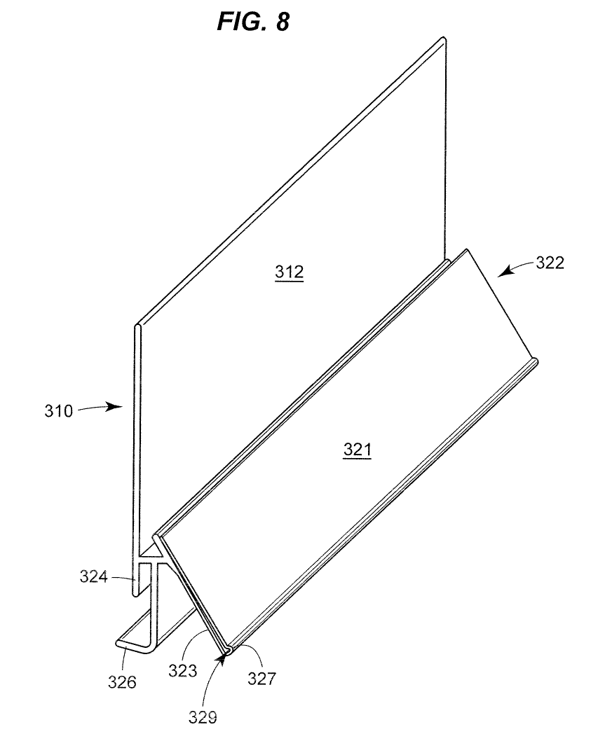

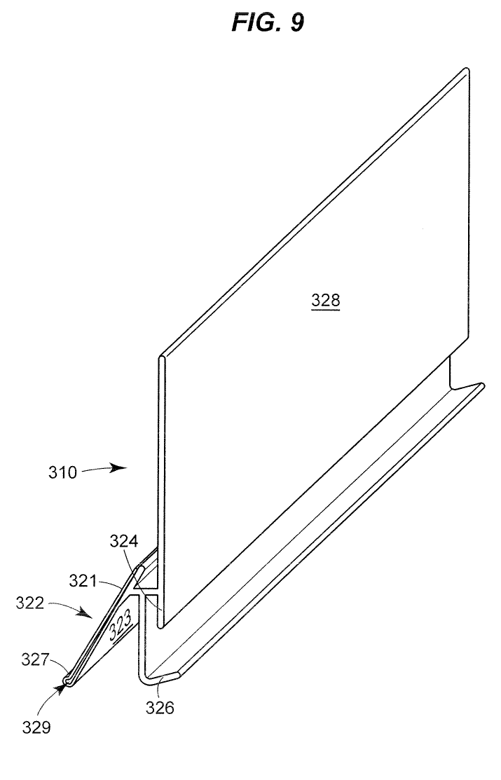

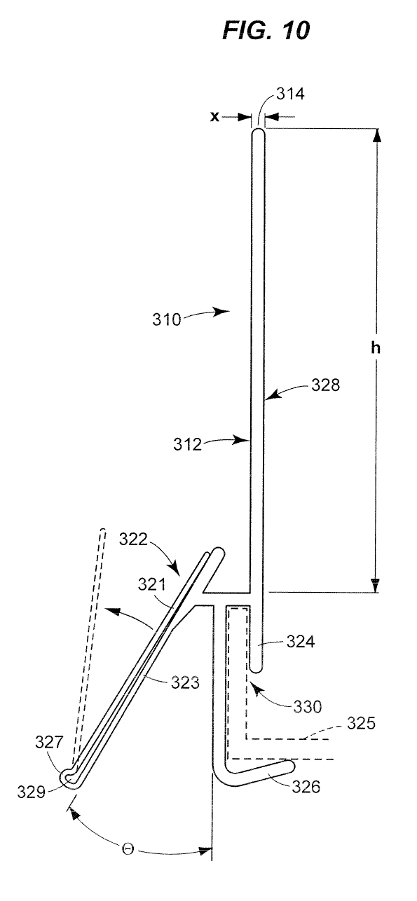

FIGS. 8, 9, and 10 show another embodiment of a price tag molding-stop plate 310 designed to attach to a mounting rail 325 in a similar fashion to the embodiment shown in FIGS. 1, 2 and 3. This embodiment, however, employs a different non-adhesive means for retaining indicia at an angle relative to the stop plate. As best seen in FIG. 10, a price tag molding 322 may be constructed with a front face member 321 and a rear face member 323 that are joined together by a bend 327 along an elongate edge of each of the front face member 321 and the rear face member 323, such as at their bottoms, with the front face member 321 overlying the rear face member 323. This combination produces an insertion slot 329 which may allow the aforementioned indicia to be slid into place from a side or from the top. As a result of the tight bend 327, the front face member 321 and rear face member 323 are biased toward one another, and thereby clamp indicia inserted therebetween. This feature allows for the use of indicia of varying thicknesses. In FIG. 10, the front face member 321 is also shown in phantom in a bent-out position, allowing for easy insertion of indicia.

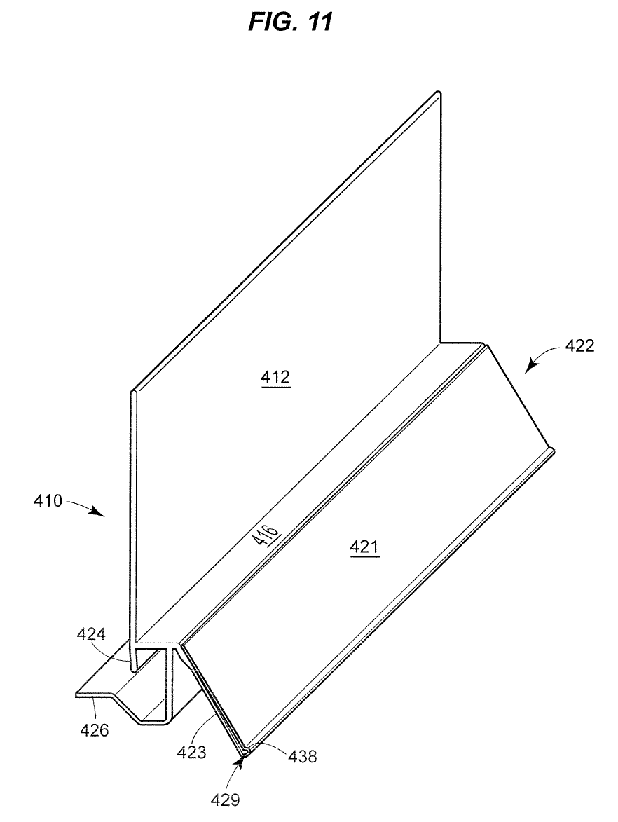

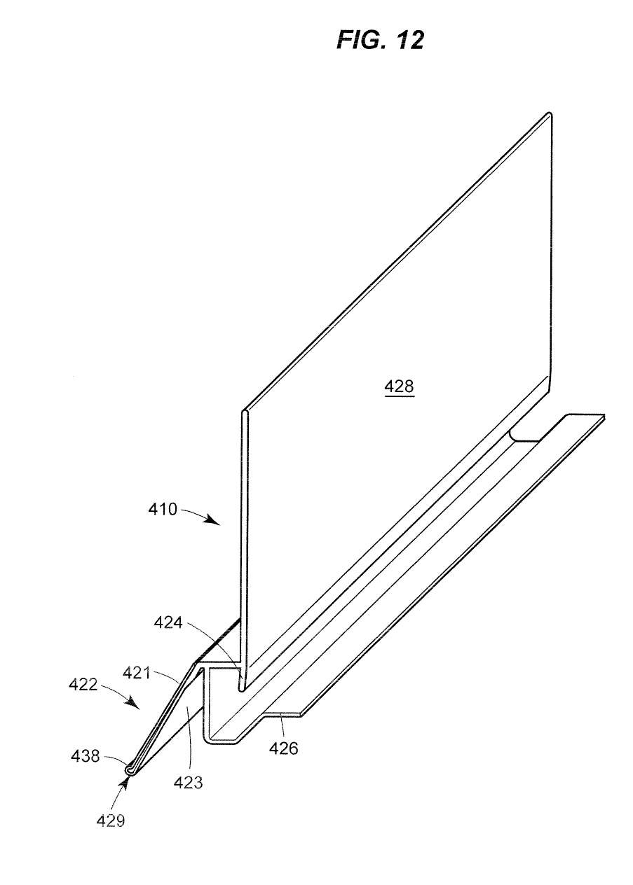

FIGS. 11, 12 and 13 show another embodiment of a price tag molding-stop plate 410 designed to attach to a pair of mounting rails 425, 427 of a shelf assembly 435 (as distinct from attaching to the mounting rail 125 of the previous embodiment of FIGS. 1, 2 and 3, and similar to the two mounting rail-type shelf shown in FIGS. 5-7).

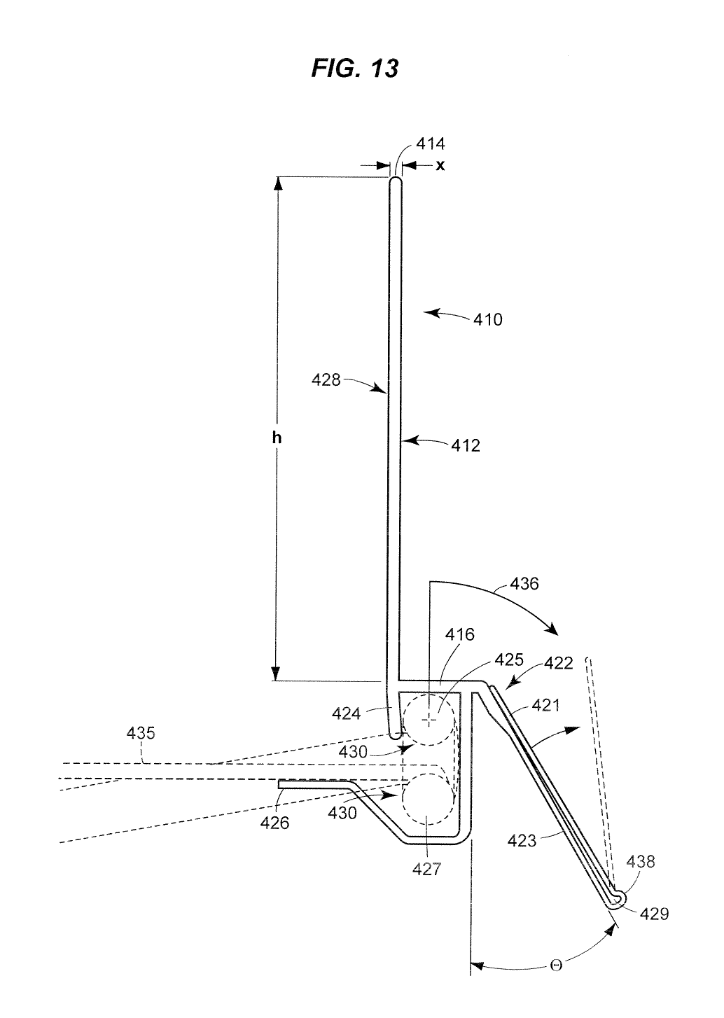

A mounting rail channel 430 (see FIG. 13), created where a mounting rail clamp 424 joins a ledge 416 and an upper portion of a price tag molding 422, tightly surrounds and attaches to an upper mounting rail 425. Similarly, a lower mounting rail clip 426 is provided to surround a lower mounting rail 427. The curvature of the lower mounting rail clip 426 provides the necessary resiliency to surround the lower mounting rail 427 and secure to it and to abut the underside of the shelf assembly 435.

A method of attaching the price tag molding/stop plate 410 to the mounting rails 425, 427 of the shelf assembly 435 is completed as follows. While facing the front of the shelf assembly 435, an installer holds the price tag molding-stop plate 410 upright and then tips it backwards, placing the upper mounting rail channel 430 over the upper mounting rail 425. The installer then rotates the price tag molding-stop plate 410 downward (as indicated by the curved arrow 436) until the lower mounting rail clip 426 abuts the underside of the shelf assembly 435, thus securing it in place. Removal of the price tag molding-stop plate 410 would be accomplished by reversing the aforementioned rotation.

The price tag molding 422 is similar to that of the previous embodiment, with a front face member 421 and a rear face member 423 that are joined together by a bend 438 along an elongate edge of each of the front face member 421 and the rear face member 423, such as at their bottoms, with the front face member 421 overlying the rear face member 423. This combination produces an insertion slot 429 which may allow the aforementioned indicia to be slid into place from a side or from the top.

In each of the embodiments disclosed herein, once the mounting rail channel has been mounted to the at least one mounting rail presented by an associated shelf, the stop plate is positioned at a substantially right angle to the associated shelf.

While various embodiments have been described, the scope of the appended claims is not intended to be limited thereto. Variations to the disclosed embodiments may be made without departing from the scope of the following claims.

What is claimed is:

1. A combination price tag molding and front-end stop plate assembly for mounting along a front shelf edge of a display shelving unit, comprising:
a stop plate for preventing articles positioned on an associated shelf from advancing forward beyond a front shelf edge of the associated shelf;
a connector ledge integrally affixed to the stop plate member and extending generally transversely therefrom;
a mounting rail channel depending from the connector ledge, the mounting rail channel further defined by an upper mounting rail clamp and a lower mounting rail clip,
at least one of the upper mounting rail clamp and the lower mounting rail clip having sufficient resiliency to facilitate mounting to at least one mounting rail presented by the associated shelf; and
a price tag molding carried by the connector ledge integrally affixed to the stop plate and extending generally transversely from the stop plate, the price tag molding including non-adhesive means for retaining indicia at an angle relative to the stop plate.

2. The assembly of claim 1, wherein the non-adhesive means for retaining indicia at an angle relative to the stop plate includes an upper price tag receiving channel and a lower price tag receiving channel spaced from and facing the upper price tag receiving channel.

3. The assembly of claim 1, wherein the non-adhesive means for retaining indicia at an angle relative to the stop plate includes a rear face member and an overlying front face member.

4. The assembly of claim 3, wherein the rear face member and front face member are joined together by a bend along an elongate edge of each of the rear face member and the front face member.

5. The assembly of claim 1, wherein the at least one mounting rail presented by the associated shelf includes a mounting rail having a generally L-shaped cross-section.

6. The assembly of claim 1, wherein the at least one mounting rail presented by the associated shelf includes at least an upper wire rod-type mounting rail and a lower wire rod-type mounting rail.

7. The assembly of claim 1, wherein, once the mounting rail channel has been mounted to the at least one mounting rail presented by an associated shelf, the stop plate is positioned at a substantially right angle to the associated shelf.

8. The assembly of claim 2, and wherein the price tag molding extends at an angle relative to the stop plate, and wherein said angle varies inversely with the height of the associated shelf to which the assembly is mounted.

9. A combination price tag molding and front-end stop plate assembly for mounting along a front shelf edge of a display shelving unit, comprising:
a stop plate extending generally upwardly for preventing articles positioned on an associated shelf from advancing forward past a front shelf edge of the associated shelf;
a connector ledge integrally affixed to the stop plate and extending generally transversely therefrom,
a price tag molding carried by the connector ledge integrally affixed to the stop plate and extending generally transversely therefrom;
the price tag molding having an upper price tag receiving channel and a lower price tag receiving channel formed thereon, said upper and lower price tag receiving channels defining a slot for receiving and displaying labeling indicia; and
a mounting rail channel carried by the connector ledge, the mounting rail channel defined by an upper mounting rail clamp and a lower mounting rail clip, the mounting rail channel having sufficient resiliency for mounting to at least one mounting rail presented by the associated shelf.

10. The assembly of claim 9, wherein the price tag molding extends at an angle relative to the stop plate.

11. The assembly of claim 10, wherein the angle is in the range from approximately 0 degrees to approximately 90 degrees.

12. The assembly of claim 9, wherein the assembly is formed as an integral injection-molded plastic component.

13. The assembly of claim 12, wherein at least the stop plate is formed of generally clear plastic material.

14. The assembly of claim 12, wherein at least the price tag molding is formed of generally clear plastic material.

15. The assembly of claim 9, wherein the at least one mounting rail presented by the associated shelf includes a mounting rail having an L-shaped cross-section.

16. The assembly of claim 9, wherein the at least one mounting rail presented by the associated shelf includes at least an upper wire rod-type mounting rail and a lower wire rod-type mounting rail.

17. The assembly of claim 9, wherein the upper mounting rail clamp and the lower mounting rail clip are in a plane that is generally parallel to, and offset from, a plane defined by the stop plate.

18. A combination price tag molding and front-end stop plate assembly for mounting along a front shelf edge of a display shelving unit, comprising:
a stop plate extending generally upwardly for preventing articles positioned on an associated shelf from advancing forward past a front shelf edge of the associated shelf;
a connector ledge integrally affixed to the stop plate and extending generally transversely therefrom,
a price tag molding carried by the connector ledge integrally affixed to the stop plate and extending generally transversely therefrom;
the price tag molding including a price tag receiving channel formed by a rear face member and an overlying front face member; and
a mounting rail channel carried by the connector ledge, the mounting rail channel defined by an upper mounting rail clamp and a lower mounting rail clip, the mounting rail channel having sufficient resiliency for mounting to at least one mounting rail presented by the associated shelf.

19. The assembly of claim 18, wherein the rear face member and the front face member of the price tag molding are joined together by a bend along an elongate edge of each of the rear face member and the front face member.

20. The assembly of claim 19, wherein the interconnection of the front face and rear face member is a biased connection, wherein that the front face member is normally biased against the rear face member so as to secure labeling indicia therebetween.

21. The assembly of claim 18, wherein the front face member is generally clear, whereby labeling indicia between the front and rear face members is visually discernable through the front face member.
